(19) United States
(12) Patent Application Publication
(10) Pub. No.: US 2010/0000679 A1
(43) Pub. Date: Jan. 7, 2010

(54) METHOD FOR BONDING MEA AND GDL OF FUEL CELL STACK

(75) Inventors: Kook Il Han, Seoul (KR); Keun Je Lee, Gyeonggi-do (KR); Sae Hoon Kim, Gyeonggi-do (KR); Bo Ki Hong, Seoul (KR); Byung Ki Ahn, Gyeonggi-do (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/352,682

(22) Filed: Jan. 13, 2009

(30) Foreign Application Priority Data
Jul. 4, 2008 (KR) 10-2008-0064688

(51) Int. Cl. C09J 163/00

(52) U.S. Cl. 156/330; 156/327; 156/331.6; 156/326; 156/338

(57) ABSTRACT

The present invention provides a method for bonding a membrane electrode assembly (MEA) and a gas diffusion layer (GDL) of a fuel cell stack, which facilitates stacking of an electrode catalyst layer of the MEA and the GDL and, at the same time, facilitates the keeping of the stacked layers for mass production of the fuel cell stack.

For this purpose, the present invention provides a method for bonding a membrane electrode assembly and a gas diffusion layer of a fuel cell stack, the method including: coating a catalyst layer on a surface of a polymer electrolyte membrane; attaching a sub-gasket on the circumference of the polymer electrolyte membrane; and stacking a gas diffusion layer onto an outer surface of the catalyst layer by bonding all or a portion of an outer surface of the sub-gasket and the circumference of the gas diffusion layer with a bonding means.

### CROSS-REFERENCE TO RELATED APPLICATION

This application claims under 35 U.S.C. §119(a) the benefit of Korean Patent Application No. 10-2008-0064688 filed Jul. 4, 2008, the entire contents of which are incorporated herein by reference.

### BACKGROUND

(a) Technical Field

The present invention relates to a method for bonding a membrane electrode assembly (MEA) and a gas diffusion layer (GDL) of a fuel cell stack.

(b) Background Art

A polymer electrolyte membrane fuel cell (PEMFC) includes an MEA and a polymer electrolyte membrane (PEM). An MEA, in which catalyst layers for a fuel electrode and an air electrode are positioned on both sides of an electrolyte membrane, is called a 3-layer MEA, and an MEA, in which GDLs are further stacked on the outside of the catalyst layers, is called a 5-layer MEA.

As shown in FIG. 1, the MEA 10 further includes a sub-gasket 16. The sub-gasket 16 is provided to facilitate handling of the MEA 10 and bonded to the circumference of both sides of the PEM 12 with a thickness greater than that of the catalyst layer 14. The sub-gasket 16 comprises a polymer film such as inert PE, PEN, and the like.

A unit cell is formed in such a manner that a bipolar plate including flow fields for supplying fuel and discharging water generated by a fuel cell reaction is stacked on the outside of the GDL of the thus formed MEA, and a plurality of such unit cells are stacked to form a fuel cell stack of a desired power level.

The 5-layered MEA can be manufactured using a catalyst coated on substrate (CCS) or catalyst coated on GDL (CCG) process. As shown in FIG. 3, the catalyst layers 14 for the fuel electrode and the air electrode are directly coated on the GDLs 18, and the catalyst layers 14 and the PEM 12 are bonded by a thermocompression bonding process, thus manufacturing a 5-layer MEA.

The 5-layered MEA can also be manufactured using a catalyst coated on membrane (CCM) process. As shown in FIG. 2, the catalyst layers 14 for the fuel electrode and the air electrode are directly coated on the PEM 12 to manufacture a 3-layer MEA 10, the GDLs 18 are then stacked on the catalyst layers 14, and the stacked GDLs 18 and catalyst layers 14 are then bonded by a thermocompression bonding process. That is, according to the CCM process, a stacking process and a bonding process are required to be performed separately.

The CCM process has the following drawbacks in terms of productivity for mass production of the fuel cell stack. For example, when the GDLs are temporarily bonded to the 3-layer MEA by the thermocompression bonding process, an interface 20, in which a fuel cell reaction occurs, is formed between the catalyst layer 14 and the GDL 18 and an interface 22 is formed between the sub-gasket 16 and the GDL 18 are formed as shown in FIG. 4. However, the bonding force between the catalyst layer 14 and the GDL 18 or the sub-gasket 16 and the GDL 18 is weak and, if the keeping (stand-by) time for mass production of the fuel cell stack is increased, the bonding force becomes further weakened, resulting in a risk that the catalyst layer 14 may be separated from the GDL 18.

One approach for increasing the bonding force is to coat an ionomer such as Nafion on the GDL before performing the thermocompression thereof to the catalyst layer; however, since the interface of the GDL being in contact with the catalyst layer has a hydrophilic property, the bonding force is not significantly increased.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides a method for bonding an MEA and a GDL of a fuel cell stack, which facilitates stacking of an electrode catalyst layer of the MEA and the GDL by bonding an overlapping portion between a sub-gasket of the MEA and the GDL and, at the same time, facilitates the keeping of the stacked layers for mass production of the fuel cell stack by increasing the bonding force.

In one aspect, the present invention provides a method for bonding a membrane electrode assembly and a gas diffusion layer of a fuel cell stack, the method comprising: coating a catalyst layer on a surface of a polymer electrolyte membrane; attaching a sub-gasket on the circumference of the polymer electrolyte membrane; and stacking a gas diffusion layer onto an outer surface of the catalyst layer by bonding all or a portion of an outer surface of the sub-gasket and the circumference of the gas diffusion layer with a bonding means.

In a preferred embodiment, the bonding means may be applied in advance to all or the portion of the outer surface of the sub-gasket, the circumference of the gas diffusion layer, or both.

In another preferred embodiment, the application of the bonding means may be performed by dot coating, line coating, dot and line coating, overall coating or any combination thereof.

In still another preferred embodiment, the bonding means may be a controlled viscosity liquid adhesive.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic cross-sectional view illustrating a configuration of a 3-layer MEA;

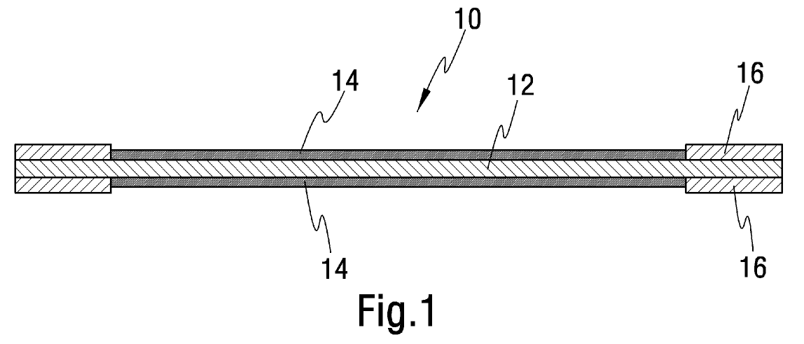

FIG. 2 is a schematic cross-sectional view illustrating a CCM process of bonding an MEA and a GDL;

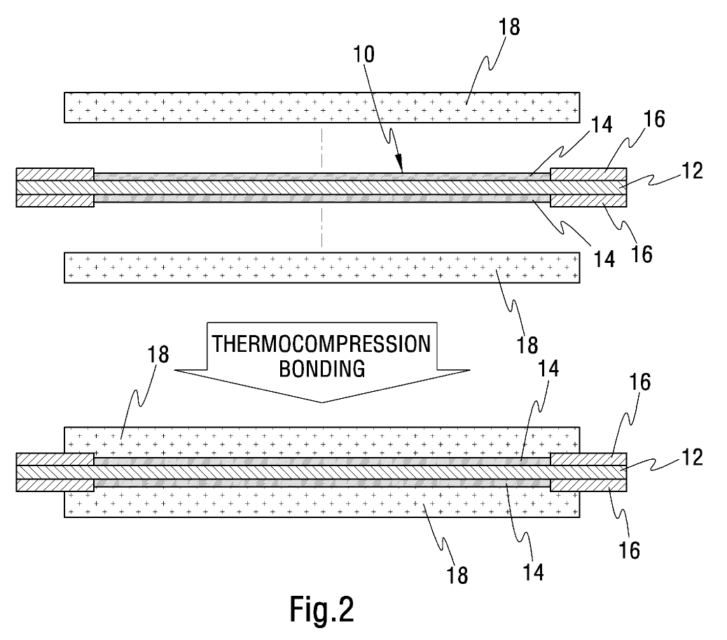

FIG. 3 is a schematic cross-sectional view illustrating a CCS or CCG process of boning an MEA and a GDL;

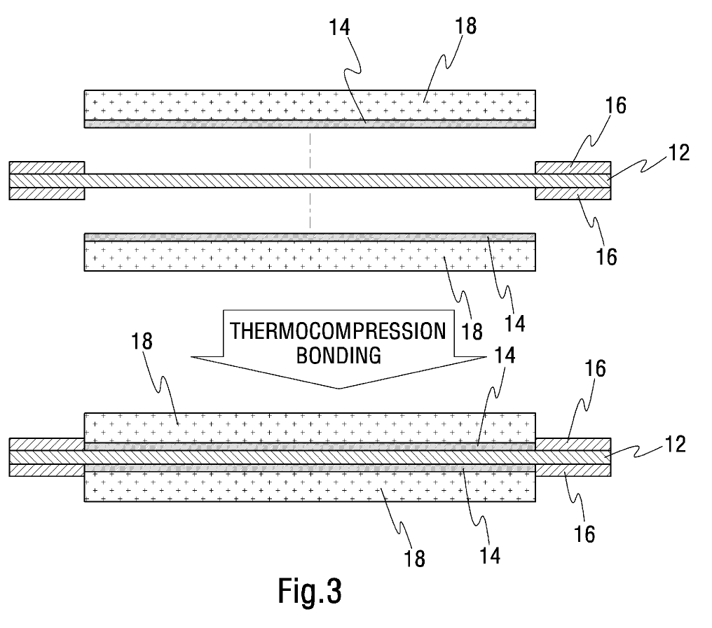

FIG. 4 is a schematic cross-sectional view illustrating a problem associated with the CCM process;

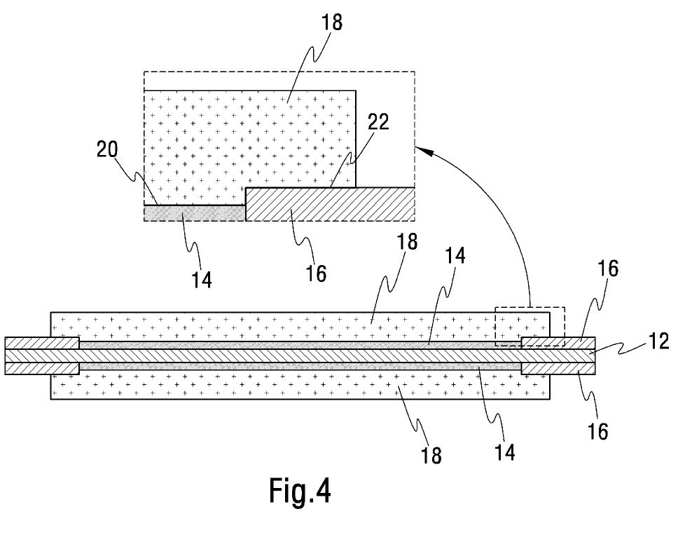

FIG. 5 is a cross-sectional view illustrating a method for bonding an MEA and a GDL of a fuel cell stack in accordance with a preferred embodiment of the present invention;

FIG. 6 is a plan view illustrating an overlapping portion of a sub-gasket of an MEA and a GDL in accordance with the present invention; and

FIG. 7 is a plan view illustrating how an adhesive is applied to bond a sub-gasket of an MEA and a GDL in accordance with the present invention.

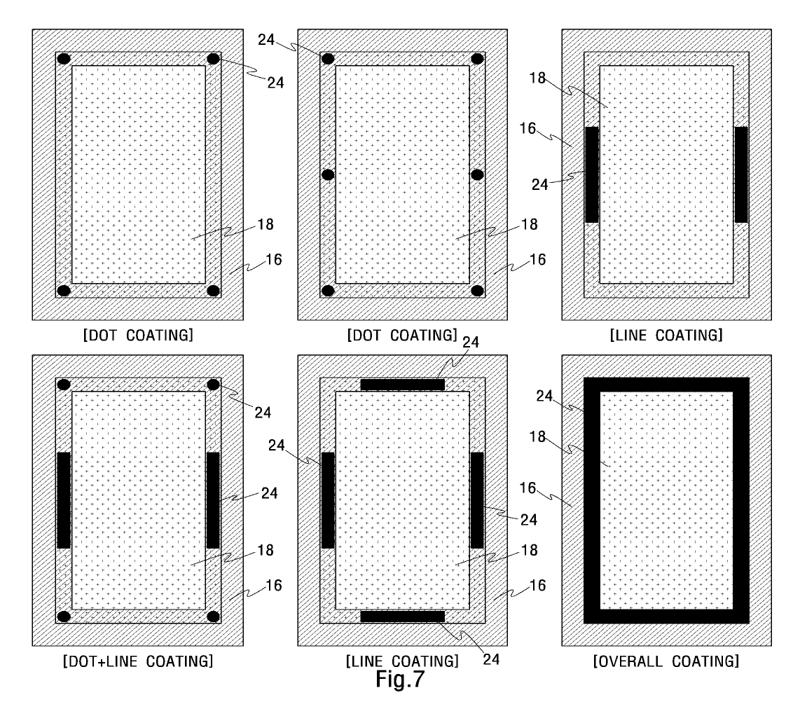

Reference numerals set forth in the Drawings includes reference to the following elements as further discussed below:

| | |
|---|---|
| 10: membrane electrode assembly (MEA) | |
| 12: polymer electrolyte membrane (PEM) | |
| 14: catalyst layer | 16: sub-gasket |
| 18: gas diffusion layer (GDL) | 20, 22: interface |
| 24: bonding means | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

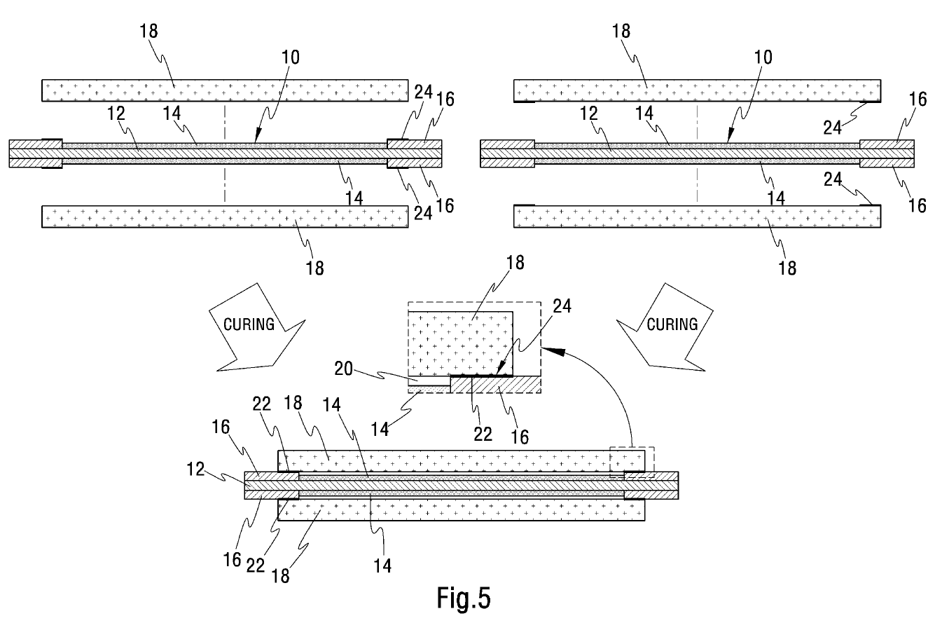

FIG. 5 is a cross-sectional view illustrating a method for bonding an MEA and a GDL of a fuel cell stack in accordance with a preferred embodiment of the present invention.

First, catalyst layers 14 for a fuel electrode and an air electrode are coated on a PEM 12 to form a 3-layer MEA 10, as described above. In more detail, the catalyst layers 14 are coated on a middle portion of respective surfaces of the PEM 12 and not coated on the circumference of the surfaces of the PEM 12. A sub-gasket 16 for providing surface pressure and maintaining airtightness is boned to the circumference of the surfaces of the PEM 12.

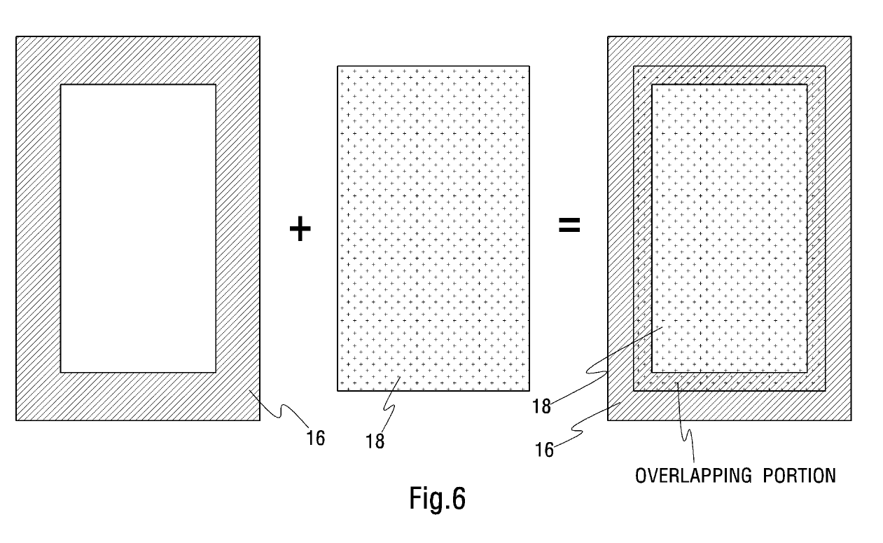

Next, GDLs 18 are stacked on the respective outer surfaces of the catalyst layers 14 by bonding all or a portion of the respective outer surfaces of the sub-gasket and the respective circumferences of the GLDs 18 with a bonding means, as shown in FIG. 6.

Suitably, the bonding means 24 may be applied in advance to the overlapping portions of the sub-gaskets and GDLs 18. In an embodiment, the bonding means 24 is applied in advance to the surface of the sub-gasket 16. In another embodiment, the bonding means 24 is applied in advance to the circumference of the GDL 18. In still another embodiment, the bonding means 24 is applied in advance to both the surface of the sub-gasket 16 and the circumference of the GDL 18.

The bonding means 24 can be applied in various ways. For example, it can be applied by dot coating, line coating, dot and line coating, overall coating or any combination thereof. For example, it can be applied by dot coating on all of the overlapping portions. It can also be applied by dot coating on a portion thereof and by overall coating on another portion thereof. Also for example, dot coating can be first applied and another coating process can be later applied.

In the present invention, any bonding means can be used as long as it provides sufficient bonding force and does not affect the fuel cell performance (e.g., reduce the surface pressure between the catalyst layers 14 and GDLs 18 or airtightness function of the sub-gasket 16). An example of the bonding means is a controlled viscosity liquid adhesive. In more detail, if the viscosity of the adhesive is too low, the adhesive can be absorbed into the porous GDL 18, which reduces the bonding force. Otherwise, if the viscosity of the adhesive is too high, a step height can be created by the adhesive on the bonding interface, which reduces the surface pressure between the catalyst layers 14 and GDLs 18.

Non-limiting examples of the controlled viscosity liquid adhesive may include the following adhesives, as disclosed in “William M. Alvino, Plastics for Electronics: Materials, Properties, and Design Applications, McGraw-Hill, Inc (1995), p. 284˜299”: (1) a thermoplastic adhesive prepared by controlling the viscosity of an solvent-based adhesive selected from the group consisting of cellulose acetate, cellulose acetate butyrate, cellulose nitrate, polyvinyl acetate, vinyl vinylidene, polyvinyl acetal, polyvinyl alcohol, polyamide, acrylic, and phenoxy; (2) a thermosetting adhesive prepared by controlling the viscosity of an solvent-based or liquid adhesive selected from the group consisting of cyanoacrylate, polyester, urea formaldehyde, resorcinol and phenol-resorcinol formaldehyde, epoxy, polyimide, acrylic, and acrylic acid diester; and (3) an elastomeric adhesive prepared by controlling the viscosity of a liquid adhesive selected from the group consisting of natural rubber, reclaimed rubber, butyl, polyisobutylene, nitrile, styrene butadiene, polyurethane, polysulfide, silicone, and neoprene.

It should be noted that that since there are various kinds of sub-gaskets and there is continuous development of MEAs, other types of adhesives may be suitably applied in addition to the above-described liquid adhesives.

According to the above-described processes, an interface 20 between the catalyst layer 14 and the GDL 18 and an interface 22 between the sub-gasket 16 and the GDL 18 are formed. Since the interface 20, in which the fuel cell reaction occurs, does not have any foreign material including bonding means, it is possible to maintain the performance of the fuel cell stack. Since the interface 22 is not related to the fuel cell reaction, the bonding means therein does not affect the performance of the fuel cell stack.

As described above, the present methods make it possible to: facilitate stacking and bonding of the catalyst layer of the MEA and the GDL at the same time, increase the bonding force; facilitate the keeping of the stacked and bonded layers for mass production of the fuel cell stack; and reduce the wait time between processes during manufacture of the fuel cell stack.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for bonding a membrane electrode assembly and a gas diffusion layer of a fuel cell stack, the method comprising:
coating a catalyst layer on a surface of a polymer electrolyte membrane;
attaching a sub-gasket on the circumference of the polymer electrolyte membrane; and
stacking a gas diffusion layer onto an outer surface of the catalyst layer by bonding all or a portion of an outer surface of the sub-gasket and the circumference of the gas diffusion layer with a bonding means.

2. The method of claim 1, wherein the bonding means is applied in advance to all or the portion of the outer surface of the sub-gasket, the circumference of the gas diffusion layer, or both.

3. The method of claim 2, wherein the application of the bonding means is performed by dot coating, line coating, dot and line coating, overall coating or any combination thereof.

4. The method of claim 1, wherein the bonding means is a controlled viscosity liquid adhesive.

5. The method of claim 4, wherein the controlled viscosity liquid adhesive is: a thermoplastic adhesive prepared by controlling the viscosity of an solvent-based adhesive selected from the group consisting of cellulose acetate, cellulose acetate butyrate, cellulose nitrate, polyvinyl acetate, vinyl vinylidene, polyvinyl acetal, polyvinyl alcohol, polyamide, acrylic, and phenoxy; a thermosetting adhesive prepared by controlling the viscosity of an solvent-based or liquid adhesive selected from the group consisting of cyanoacrylate, polyester, urea formaldehyde, resorcinol and phenol-resorcinol formaldehyde, epoxy, polyimide, acrylic, and acrylic acid diester; or an elastomeric adhesive prepared by controlling the viscosity of a liquid adhesive selected from the group consisting of natural rubber, reclaimed rubber, butyl, polyisobutylene, nitrile, styrene butadiene, polyurethane, polysulfide, silicone, and neoprene.
